(19) United States
(12) Patent Application Publication
(10) Pub. No.: US 2016/0059330 A1
(43) Pub. Date: Mar. 3, 2016

(54) OFFSET SAW BLADE

(71) Applicant: Wilbert Cartwright, Altoona, PA (US)

(72) Inventor: Wilbert Cartwright, Altoona, PA (US)

(21) Appl. No.: 14/471,234

(22) Filed: Aug. 28, 2014

(51) Int. Cl. B23D 61/12; B21D 11/10; B23D 65/00

(52) U.S. Cl. CPC B23D 61/123; B23D 65/00; B21D 11/10

(57) ABSTRACT

An offset blade assembly and method of fabrication which includes: a straight saw blade; a heel extending at a 90 degree angle from the saw blade; an extension extending from the heel, where the extension is parallel to the straight saw blade; and a connection end, where the connection end is provided on the extension and is available for attachment to a power saw. The offset blade may be used a reciprocating saw.

### BACKGROUND OF THE INVENTION

The present invention relates to a saw blade that is used to cut flush to the surface area in order to have a clean cut.

### DESCRIPTION OF RELATED ART

Saw blades are used in various applications for cutting wood, metal and other surfaces. Saw blades may be circular or straight saws depending on application and use. Many handsaws include straight saw blades and circular saw blades are usually used on hand powered tools. Further another commonly used power tool is a reciprocating saw, where the blade is connected to a mounting piece within the saw and the blade reciprocates through a reciprocating movement associated with the mounting piece. Some contractors are required to cut posts at a flush position with an underlying surface. Cutting a post at a flush location is difficult to do with a straight saw due to the angle that is usually required to apply the saw across the post. Many times individuals must make multiple cuts to provide a flush cut over a surface. Further the user may have to actually bend the saw to have a flush cut across a flat surface. As a consequence, it would be advantageous to have a saw blade that provided an effective means to cut across a flat surface when using a reciprocating saw.

### SUMMARY OF THE INVENTION

The present invention relates to an offset blade assembly and method of fabrication comprising: a straight saw blade; a heel extending at a 90 degree angle from the saw blade; an extension extending from the heel, where the extension is parallel to the straight saw blade; and a connection end, where the connection end is provided on the extension and is available for attachment to a power saw. The offset blade may be used a reciprocating saw.

### BRIEF DESCRIPTION OF DRAWINGS

FIG. 1 depicts an offset saw blade in accordance with the present invention.

### DETAILED DESCRIPTION

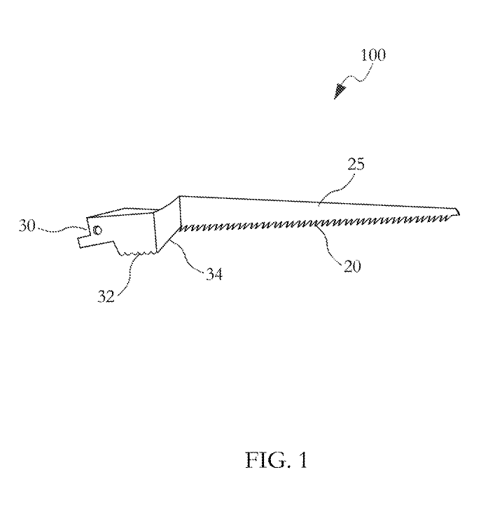

The present invention relates to an offset saw blade that is configured to provide an effective means to cut a flush cut over a flat surface. In reference to FIG. 1, an offset saw blade 100 is depicted. This offset blade 100 includes a blade 25 with a series of teeth 20 along a cutting edge of the blade 25. The blade 100 connects to a heel 34 that is perpendicular to the blade 25. The heel 34 includes an extension 32 that extends in the opposite direction of the blade 25 where the extension 32 is substantially parallel to the blade 25. The heel 34 and extension 32 creates an offset of the blade 25 from the extension 32. A connection end 30 of the extension 32 provides a means for connecting the blade assembly to a reciprocating saw. The heel 34 extending at a 90 degree from the blade 25 offsets the reciprocating connection at the connection and 30.

During use this offset blade 100 is mounted within a reciprocating saw that may be electric or battery operated. The blade 25 may be laid flat on a flat surface to enable the flush cut across a post. The offset heel 34 allows the user to operate a reciprocating saw so that the blade 25 remains straight and flush against the flat surface. The blade assembly avoids the necessity of bending a straight blade and alleviates the need for multiple cuts in order to provide a flush cut across a flat surface.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An offset blade assembly comprising:
a. a straight saw blade;
b. a heel extending at a 90 degree angle from the saw blade;
c. an extension extending from the heel, where the extension is parallel to the straight saw blade; and
d. a connection end, where the connection end is provided on the extension and is available for attachment to a power saw.

2. The offset blade assembly according to claim 1 wherein the power saw is a reciprocating saw.

3. A method of fabricating an offset blade comprising the steps of:
a. bending a heel of a straight saw blade, where the bend creates an angle;
b. providing a second bend on the heel, creating an extension from the heel; and
c. creating a connection end on a distal end of the extension, where the connection end is available for attachment to a power saw.

4. The method of fabricating according to claim 3, where the step of bending creates about a ninety angle between the saw blade and the heel.

5. The method of fabricating according to claim 4, wherein the step of providing the second bend places the extension in parallel with the saw blade.
